(19) United States
(12) Patent Application Publication
(10) Pub. No.: US 2013/0147946 A1
(43) Pub. Date: Jun. 13, 2013

(54) LENS APPARATUS FOR INSPECTING OBJECT AND MACHINE VISION SYSTEM INCLUDING THE SAME

(71) Applicants: Ju-Hwa SON, Changwon-city (KR); Kyoung-Sik JEONG, Changwon-city (KR); Suck-Ha WOO, Changwon-city (KR); Je-Youn JEE, Changwon-city (KR)

(72) Inventors: Ju-Hwa SON, Changwon-city (KR); Kyoung-Sik JEONG, Changwon-city (KR); Suck-Ha WOO, Changwon-city (KR); Je-Youn JEE, Changwon-city (KR)

(73) Assignee: SAMSUNG TECHWIN CO., LTD., Changwon-city (KR)

(21) Appl. No.: 13/559,703

(22) Filed: Jul. 27, 2012

(30) Foreign Application Priority Data
Dec. 8, 2011 (KR) 10-2011-0131110

(51) Int. Cl. G02B 15/14; F21V 5/04; H04N 7/18; F21V 13/02

(52) U.S. Cl. 348/126; 362/231; 362/293; 362/311.01; 359/691; 348/E07.085

(57) ABSTRACT

Provided are a lens apparatus and a machine vision system including the lens apparatus. The lens apparatus includes: a first lens group and a second lens group which are designed to use a wavelength of light of a first single color as a reference wavelength and disposed on opposite sides of an aperture; and a converter lens group which is disposed at an object side of the first lens group, wherein the converter lens group performs selectively at least one of a first conversion for converting a magnification, and a second conversion for converting the reference wavelength.

### CROSS-REFERENCE TO RELATED PATENT APPLICATION

This application claims priority from Korean Patent Application No. 10-2011-0131110, filed on Dec. 8, 2011, in the Korean Intellectual Property Office, the disclosure of which is incorporated herein in its entirety by reference.

### BACKGROUND

1. Field

Apparatuses consistent with exemplary embodiments relate to a lens apparatus for inspecting an object and a machine vision system including the lens apparatus.

2. Description of the Related Art

A printed circuit board (PCB) is an electronic component which functions as a wire electrically connecting electronic components to one another and supplying electric power, and on which electronic elements are fixed. Examples of a PCB include a chip-on-film (COF), a tape automated bonding (TAB), or a board-on-chip (BOC). It is very important to inspect PCB patterns in the fields of flexible or rigid circuit boards such as COF, TAB, BOC, or displays. Since many fine and complicated patterns are formed in a flexible or a rigid PCB in electronic information appliances as the electronic information appliances are formed smaller, wrong operation of the electronic information appliances may occur when defective patterns are formed.

### SUMMARY

One or more exemplary embodiments provide a lens apparatus for inspecting an object to determine a state of the object, for example, a circuit board, and a machine vision system including the lens apparatus. The state of the object may be defects of the object.

According to an aspect of an exemplary embodiment, there is provided a machine vision system to determine a state of an object, the machine vision system including: an illuminating apparatus which irradiates light of a first single color or light in which the first single color and a second single color are mixed onto the object; and a lens apparatus designed to use a wavelength of light of the first single color as a reference wavelength, the lens apparatus including a first lens group and a second lens group disposed on opposite sides of an aperture and receiving light reflected by the object, wherein the lens apparatus further includes a converter lens group which performs at least one of a first conversion for converting a magnification of the lens apparatus, and a second conversion for converting the reference wavelength of the lens apparatus, and wherein each of the first, second and converter lens groups comprises one or more lenses.

The converter lens group may be disposed at an object side of the first lens group.

The converter lens group may include four or less lenses.

The first lens group may include a first sub lens group disposed adjacent to the aperture, having a negative refractive power, and comprising at least one lens; and a second sub lens group disposed at an object side of the first sub lens group, having a positive refractive power, and comprising at least one lens. The second lens group may include a first sub lens group disposed adjacent to the aperture, having a negative refractive power, and comprising at least one lens; and a second sub lens group disposed at an image side of the first sub lens group, having a positive refractive power; and comprising at least one lens.

The illuminating apparatus may irradiate the light of the at least one color selectively in at least one of the following manners: (i) the light of the first single color or the light in which the first single color and a second single color are mixed is incident on the object through an optical axis of the lens apparatus; and (ii) the light of the first single color or the light in which the first single color and the second single color are mixed is incident at an angle inclined with respect to the optical axis of the lens apparatus.

The machine vision system may further include: a solid state imaging device which converts the light reflected by the object into an electric signal, and stores the electric signal as an image; and a state determination apparatus which determines the state of the object by using the image.

The defect determination apparatus may determine whether the object has a defect by comparing the image with image information about the object that is stored in advance.

According to another aspect, there is provided a lens apparatus receiving light reflected from an object, the lens apparatus including: a first lens group and a second lens group which are designed to use a wavelength of light of a first single color as a reference wavelength and disposed on opposite sides of an aperture; and a converter lens group which is disposed at an object side of the first lens group, wherein the converter lens group performs selectively at least one of a first conversion for converting a magnification, and a second conversion for converting the reference wavelength.

The first lens group and the second lens group may be substantially symmetrical with each other as a Gaussian type about the aperture.

The converter lens group may be disposed at an object side of the first lens group.

The reference wavelength of the first lens group and the second lens group may be a wavelength of single color light.

The reference wavelength of the first and second lens groups may be a wavelength of red light, and the second conversion of the converter lens group may convert the reference wavelength into a wavelength of blue light or green light.

The converter lens group may perform only the first conversion among the first and second conversions.

### BRIEF DESCRIPTION OF THE DRAWINGS

The above and other aspects will become more apparent by describing in detail exemplary embodiments thereof with reference to the attached drawings, in which:

FIG. 1 is a schematic diagram of a machine vision system according to an exemplary embodiment;

FIG. 2 is a diagram of a lens apparatus shown in FIG. 1, according to an exemplary embodiment;

FIG. 3 is a modulation transfer function (MTF) graph showing a resolution of the lens apparatus of FIG. 2, according to an exemplary embodiment;

FIG. 4 is a diagram of a lens apparatus according to another exemplary embodiment;

FIG. 5 is an MTF graph showing a resolution of the lens apparatus of FIG. 4, according to an exemplary embodiment;

FIG. 6 is a diagram of a lens apparatus according to another embodiment, wherein the lens apparatus includes a converter lens group, according to an exemplary embodiment;

FIG. 7 is an MTF graph showing a resolution of the lens apparatus of FIG. 6, according to an exemplary embodiment;

FIG. 8 is a diagram of a lens apparatus according to another embodiment, wherein the lens apparatus includes a converter lens group, according to an exemplary embodiment;

FIG. 9 is an MTF graph showing a resolution of the lens apparatus of FIG. 8, according to an exemplary embodiment;

FIG. 10 is a diagram of a lens apparatus according to another exemplary embodiment, wherein the lens apparatus includes a converter lens group;

FIG. 11 is an MTF graph showing a resolution of the lens apparatus of FIG. 10, according to an exemplary embodiment;

FIG. 12 is a diagram of a lens apparatus according to another exemplary embodiment, wherein the lens apparatus includes a converter lens group;

FIG. 13 is an MTF graph showing a resolution of the lens apparatus of FIG. 12, according to an exemplary embodiment; and

FIG. 14 is an MTF graph showing a resolution when white light is irradiated onto an object, in a comparative example, according to an exemplary embodiment.

### DETAILED DESCRIPTION OF EXEMPLARY EMBODIMENTS

The inventive concept now will be described more fully hereinafter with reference to the accompanying drawings, in which illustrative exemplary embodiments are shown. This inventive concept may, however, be embodied in many different forms and should not be construed as limited to the exemplary embodiments set forth herein; rather, these exemplary embodiments are provided so that this disclosure will be thorough and complete, and will fully convey the scope of the inventive concept to those skilled in the art. Like numbers refer to like elements throughout. It will be understood that although the terms “first” and “second” are used herein to describe various elements, these elements should not be limited by these terms. These terms are only used to distinguish one element from another element. Thus, a first element discussed below could be termed a second element, and similarly, a second element may be termed a first element without departing from the teachings of this disclosure. The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Expressions such as “at least one of,” when preceding a list of elements, modify the entire list of elements and do not modify the individual elements of the list.

An object 1 according to an exemplary embodiment is a product that needs to be inspected for defects, for example, a printed circuit board (PCB). An object 1 according to another exemplary embodiment may be all kinds of objects of which defects are detected by using machine vision technology. Hereinafter, a case where the object 1 is a PCB is described.

In the present specification, single color light denotes the same meaning as light of a first color, and two-color light denotes light in which a first color and a second color are mixed.

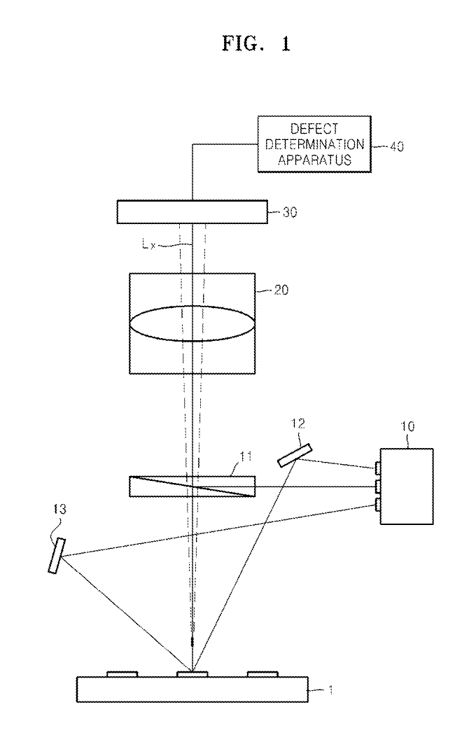

FIG. 1 schematically shows a machine vision system according to an exemplary embodiment. The machine vision system is an apparatus that photographs an object 1, which is a PCB, to determine whether the PCB has a good quality or bad quality through an algorithm. The machine vision system may include an illuminating apparatus 10, a lens apparatus 20, a solid state imaging device 30 that converts light received through the lens apparatus 20 into an electric signal, and a defect determination apparatus 40 that determines whether the object 1 has defects.

The illuminating apparatus 10 may be disposed on a side of the machine vision system and irradiates single-color or two-color light as illumination light. For example, when the object 1 is a PCB, circuit patterns may include copper. Here, the illuminating apparatus 10 may irradiate red light to which the copper reacts sensitively.

As another exemplary embodiment, the illuminating apparatus 10 may irradiate two-color light, that is, red light and green light. The red light and the green light may be simultaneously irradiated. An outer appearance of the PCB may be inspected by using the green light while improving sensitivity of image detection of the circuit patterns by using the red light.

As another exemplary embodiment, the illuminating apparatus 10 may irradiate two-color light, that is, blue light and white light. Since the blue light emitted from the illuminating apparatus 10 is useful for finding defects and has low brightness, the white light having high light intensity may compensate for the low brightness of the blue light.

The illuminating apparatus 10 may include a plurality of light-emitting diodes (LEDs). The plurality of LEDs may irradiate light of different colors from each other. Light irradiated from some of the plurality of LEDs, hereafter referred to as a “first set of LEDs”, is incident into a beam splitter 11, and light irradiated from some other LEDs, hereafter referred to as a “second set of LEDs”, may be incident to the PCB by reflective members 12 and 13. The first set of the LEDs of the illuminating apparatus 10 and the beam splitter 11 may configure a coaxial type illumination unit, and the second set of LEDs and the reflective members 12 and 13 may configure a reflection type illumination unit.

The reflection type illumination unit irradiates light onto the PCB at an angle inclined with respect to an optical axis Lx of the lens apparatus 20. The light irradiated from the second set of LEDs is reflected by the reflective members 12 and 13 to proceed toward the PCB. The light proceeding toward the PCB by the reflective members 12 and 13 is reflected by the PCB, and then incident into the lens apparatus 20. The reflective members 12 and 13 may be, for example, mirrors.

The coaxial type illumination unit irradiates light toward the PCB from a front side of the lens apparatus 20 on a coaxial line of the optical axis Lx of the lens apparatus 20. The light irradiated from the first set of LEDs proceeds toward the PCB along the optical axis Lx of the lens apparatus 20 through the beam splitter 11, and then, is reflected by the PCB and incident into the lens apparatus 20. The beam splitter 11 may be, for example, a prism or a half-mirror.

In the present exemplary embodiment, through the beam splitter 11, the light emitted from the first set of LEDs is irradiated toward the PCB from the front side of the lens apparatus 20 coaxially with the optical axis Lx of the lens apparatus 20. However, the inventive concept is not limited thereto, provided that the light emitted from the LEDs may proceed toward the PCB coaxially with the optical axis Lx of the lens apparatus 20.

In the present exemplary embodiment, the illuminating apparatus 10 may configure the reflection type illumination unit and the coaxial type illumination unit; however, the inventive concept is not limited thereto. In another exemplary embodiment, the illuminating apparatus 10 may only configure the reflection type illumination unit, or the coaxial type illumination unit to irradiate light onto the PCB. In still another exemplary embodiment, the illuminating apparatus 10 may configure the reflection type illumination unit and the coaxial type illumination unit, and the reflection type illumination unit and the coaxial type illumination unit may be selectively used.

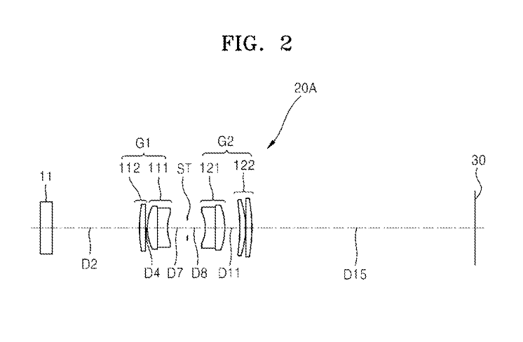

The lens apparatus 20 receives the light reflected by the PCB to form an image of the PCB on the solid state imaging device 30. To do this, the lens apparatus 20 may include a basic lens group including a first lens group, a second lens group, and an aperture, and may further include a converter lens group. A structure of the lens apparatus 20 will be described with reference to FIGS. 2 through 14.

The solid state imaging device 30 may convert the light received by the lens apparatus 20 into an electric signal, and may store the electric signal as a black-and-white image. The solid state imaging device 30 transmits information about the stored black-and-white image to the defect determination apparatus 40. In the information about the black-and-white image of the object 1, for example, the PCB, white color may denote circuit patterns and black color may denote portions other than the circuit patterns. The solid state imaging device 30 may include a charge-coupled device (CCD) or a complementary metal-oxide semiconductor (CMOS).

The defect determination apparatus 40 may determine whether the PCB has defects. The defect determination apparatus 40 may store information about a normal state image of the PCB in advance as reference data. The defect determination apparatus 40 may determine whether the PCB is defective by comparing the reference data with data transmitted from the solid state imaging device 30. The defects of the PCB may include open, short, mouse bit (pit), and protrusion of the circuit patterns.

Hereinafter, the lens apparatus 20 is described in more detail with reference to FIGS. 2 through 14.

Referring to FIGS. 2, 4, 6, 8, 10, and 12, a first lens group G1 and a second lens group G2 of the lens apparatuses 20A to 20F are disposed on opposite sides of an aperture ST. The first and second lens groups G1 and G2 may have a substantial Gaussian type symmetric structure, according to an exemplary embodiment.

The first lens group G1 may include a 1-1 lens group 111, 211, 311, 411, 511, or 611 that is adjacent to the aperture ST, has a negative refractive power, and includes a cemented lens, and a 1-2 lens group 112, 212, 312, 412, 512, or 612 that is disposed at an object side and has a positive refractive power.

The second lens group G2 may include a 2-1 lens group 121, 221, 321, 421, 521, or 621 that is adjacent to the aperture ST, has a negative refractive power, and includes a cemented lens, and a 2-2 lens group 122, 222, 322, 422, 522, or 622 that is disposed at an image side, has a positive refractive power.

The first lens group G1 and the second lens group G2 are designed to use a wavelength of a certain single color light of the light emitted from the illuminating apparatus 10 as a reference wavelength. The first and second lens groups G1 and G2 may use a wavelength of single color light emitted from the illuminating apparatus 10 as a reference wavelength, for example, a wavelength of red light.

In the lens apparatuses 20C to 20F, a converter lens group 350, 450, 550, and 650 may be disposed at an object side of the first lens group G1, respectively, to change magnification of the lens apparatus 20C to 20F (first conversion), or to change a reference wavelength of the lens apparatus 20C to 20F (second conversion). The converter lens group 350, 450, 550, or 650 may be mounted in the machine vision system as shown in FIG. 1 to selectively perform at least one of the first and second conversions.

Each of the converter lens groups 350, 450, 550, and 650 includes four or less lenses. The lens apparatuses 20C to 20F, including the converter lens group 350, 450, 550, and 650, use a total 7 to 11 lenses, and thus, it is advantageous to reduced costs.

Hereinafter, a detailed structure of the lens apparatus 20A to 20F, and the first and second conversions are described with reference to FIGS. 2 through 13. In following description, R denotes a radius of curvature of each of the lens surfaces or surfaces of a optical member forming the lens apparatus 20A to 20F, Dn denotes a thickness of a center of the lens or the optical member, or a distance between lenses, nd denotes a d-line refractive index, and vd denotes an Abbe number of the d-line.

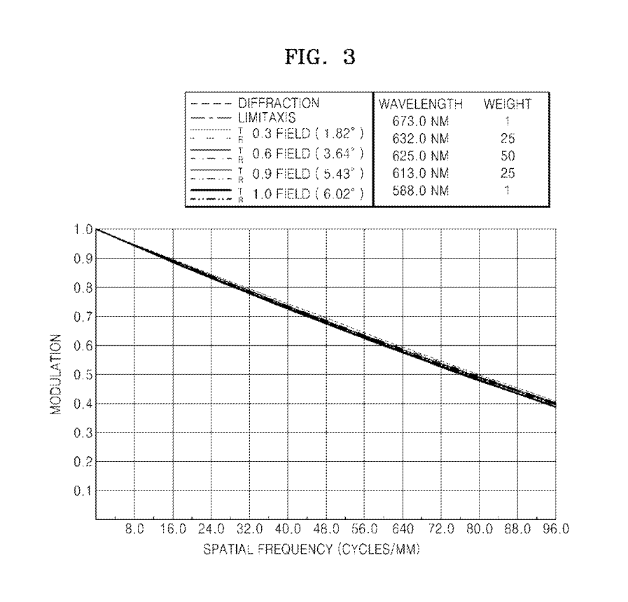

FIG. 2 is a diagram showing the lens apparatus 20 (20A) shown in FIG. 1, and FIG. 3 is a modulation transfer function (MTF) graph showing a resolution of the lens apparatus 20A of FIG. 2.

The lens apparatus 20A of the present exemplary embodiment includes a basic lens group, without a converter lens group. The basic lens group is designed to use a wavelength of red light as a reference wavelength.

Referring to FIG. 2, the lens apparatus 20A includes the first and second lens groups G1 and G2 that are disposed on opposite sides of the aperture ST. The 1-1 lens group 111 and the 2-1 lens group 121 that include cemented lenses and have negative refractive powers, respectively, are disposed on opposite sides of the aperture ST. The 1-2 lens group 112 having a positive refractive power is disposed at an object side of the 1-1 lens group 111, and the 2-2 lens group 122 having a positive refractive power is disposed at an image side of the 2-1 lens group 121.

Table 1 shows design data of the lens apparatus 20A shown in FIG. 2. In the present exemplary embodiment, a distance between the PCB and the prism, that is, the beam splitter 11, is 49.0000 mm.

Fno.=3.8 (effective Fno. 8.0)

EFL=141 mm

magnification=×1.3

TABLE 1

| Lens surface | | | | |
|---|---|---|---|---|
| (Sn) | Rn | Dn | Nd | vd |
| S1 | INFINITY | 12.000000 | 1.5168 | 64.1673 |
| S2 | INFINITY | 89.000000 | | |
| S3 | 104.72297 | 6.000000 | 1.744001 | 44.8991 |
| S4 | INFINITY | 2.305673 | | |
| S5 | 44.49409 | 10.000000 | 1.744001 | 44.8991 |
| S6 | INFINITY | 10.000000 | 1.688930 | 31.1605 |
| S7 | 30.89249 | 20.698549 | | |
| S8 | INFINITY | 18.053872 | | |
| S9(stop) | −30.35809 | 10.000000 | 1.755200 | 27.5305 |
| S10 | INFINITY | 10.000000 | 1.743299 | 49.2216 |
| S11 | −49.34386 | 15.000000 | | |
| S12 | −159.14781 | 6.000000 | 1.670028 | 47.1965 |
| S13 | −73.10464 | 0.500000 | | |
| S14 | INFINITY | 6.000000 | 1.531720 | 48.8408 |
| S15 | −140.55668 | 227.404053 | | |
| S16(IMAGE) | INFINITY | | | |

In FIG. 3, an x-axis denotes a spatial frequency, and a y-axis denotes modulation. Referring to FIG. 3, the lens apparatus 20A of the present exemplary embodiment shows a resolving power of about 40% based on 96 cycles/mm, which is the Nyquist frequency.

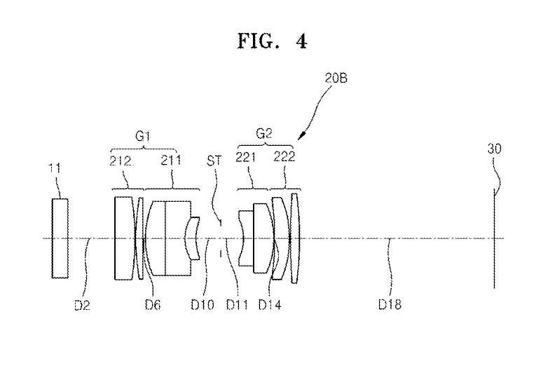

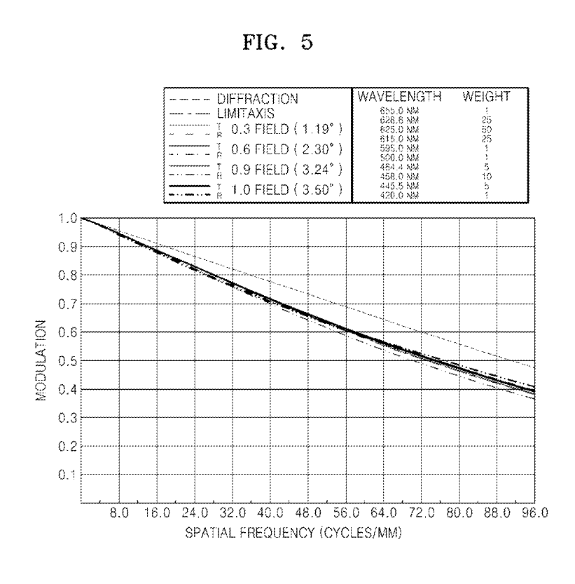

FIG. 4 is a diagram showing the lens apparatus 20B according to another exemplary embodiment, and FIG. 5 is an MTF graph showing a resolving power of the lens apparatus 20B of FIG. 4.

The lens apparatus 20B of the present exemplary embodiment includes the basic lens group, without a converter lens group. The basic lens group is designed to use a wavelength of two-color light of red light and blue light as a reference wavelength.

Referring to FIG. 4, the lens apparatus 20B includes the first and second lens groups G1 and G2 that are disposed on opposite sides of an aperture ST. The 1-1 lens group 211 and the 2-1 lens group 221 that include cemented lenses and have negative refractive powers, respectively, are disposed on opposite sides of the aperture ST. The 1-2 lens group 212 having a positive refractive power is disposed at an object side of the 1-1 lens group 211, and the 2-2 lens group 222 having a positive refractive power is disposed at an image side of the 2-1 lens group 221.

Table 2 shows design data of the lens apparatus 20B shown in FIG. 4. In the present exemplary embodiment, a distance between the PCB and the prism, that is, the beam splitter 11, is 49.0000 mm.

Fno.=2.7 (effective Fno. 7.45)

EFL=162 mm

magnification=×1.3

TABLE 2

| Lens surface | | | | |
|---|---|---|---|---|
| (Sn) | Rn | Dn | Nd | vd |
| S1 | INFINITY | 12.000000 | 1.516800 | 64.1673 |
| S2 | INFINITY | 35.507724 | | |
| S3 | INFINITY | 15.000000 | 1.744001 | 44.8991 |
| S4 | −141.92903 | 0.500000 | | |
| S5 | 132.37653 | 5.523604 | 1.744001 | 44.8991 |
| S6 | INFINITY | 1.660777 | | |
| S7 | 55.47332 | 15.000000 | 1.744001 | 44.8991 |
| S8 | INFINITY | 15.000000 | 1.728252 | 28.3196 |
| S9 | 23.39030 | 8.275118 | 1.717007 | 47.8290 |
| S10 | 31.89692 | 16.137046 | | |
| S11(stop) | INFINITY | 19.635646 | | |
| S12 | −26.58689 | 7.710582 | 1.755200 | 27.5305 |
| S13 | INFINITY | 15.000000 | 1.603109 | 60.5989 |
| S14 | −49.26224 | 0.500195 | | |
| S15 | −187.91147 | 11.437513 | 1.744001 | 44.8991 |
| S16 | −59.74108 | 0.500000 | | |
| S17 | 315.99286 | 6.867899 | 1.744001 | 44.8991 |
| S18 | −185.76365 | 146.35603 | | |
| S19(image) | INFINITY | | | |

In FIG. 5, an x-axis denotes a spatial frequency, and a y-axis denotes a modulation. Referring to FIG. 5, the lens apparatus 20B of the present embodiment shows a resolving power of about 38% based on 96 cycles/mm, which is the Nyquist frequency.

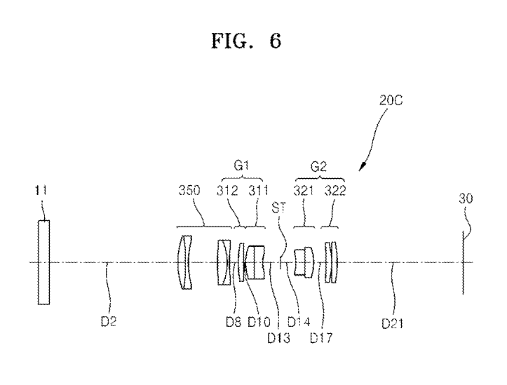

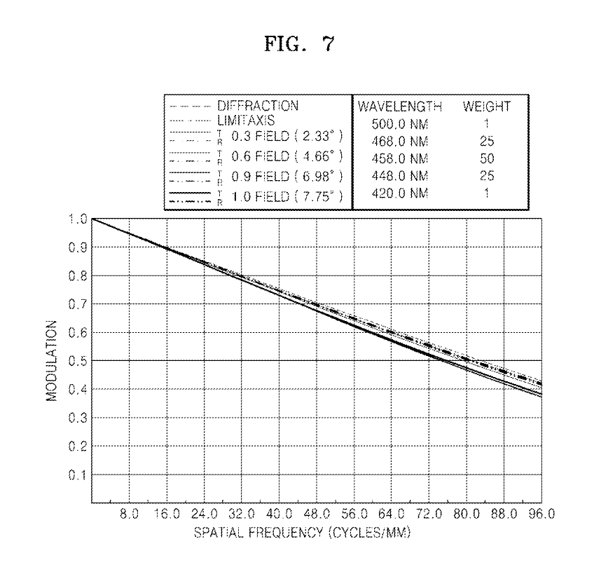

FIG. 6 is a diagram showing the lens apparatus 20C according to another exemplary embodiment, and FIG. 7 is an MTF graph showing a resolving power of the lens apparatus 20C of FIG. 6.

The lens apparatus 20C of the present exemplary embodiment includes a basic lens group that is designed to use a wavelength of red light as a reference wavelength, and includes a converter lens group 350 to perform the first and second conversions.

A lens apparatus having a basic lens group at an initial magnification of ×1.3 is converted into the lens apparatus 20C having a magnification of ×0.65 by the first conversion of the converter lens group 350. In addition, the lens apparatus which does not have the converter lens group 350 and is designed to use a wavelength of a single color light, for example, red light, as a reference wavelength is converted into the lens apparatus 20C using a wavelength of another single color light, that is, blue light, as a reference wavelength by a second conversion of the converter lens group 350.

That is, according to the present exemplary embodiment, the lens apparatus including the basic lens group initially designed to use the wavelength of the red light, and having a magnification of ×1.3 is converted into the lens apparatus 20C using the wavelength of the blue light as the reference wavelength and having a magnification of ×0.65 by the converter lens group 350.

Referring to FIG. 6, the lens apparatus 20C includes the first and second lens groups G1 and G2 that are disposed on opposite sides of the aperture ST. The 1-1 lens group 311 and the 2-1 lens group 321 that include cemented lenses and have negative refractive powers, respectively, are disposed on opposite sides of the aperture ST. The 1-2 lens group 312 having a positive refractive power is disposed at an object side of the 1-1 lens group 311, and the 2-2 lens group 322 having a positive refractive power is disposed at an image side of the 2-1 lens group 321.

The converter lens group 350 includes four lenses.

Table 3 shows design data of the lens apparatus 20C shown in FIG. 6. In the present exemplary embodiment, a distance between the PCB and the prism, that is, the beam splitter 11, is 49.0000 mm.

Fno.=6.8 (effective Fno. 10.6)

EFL=148 mm

magnification=×0.65

TABLE 3

| Lens surface | | | | |
|---|---|---|---|---|
| (Sn) | Rn | Dn | Nd | vd |
| S1 | INFINITY | 12.000000 | 1.516800 | 64.1673 |
| S2 | INFINITY | 148.603200 | | |
| S3 | 75.14308 | 9.379140 | 1.603109 | 60.5989 |
| S4 | −158.13676 | 3.000000 | 1.755200 | 27.5305 |
| S5 | 87.28207 | 33.659877 | | |
| S6 | 203.87834 | 10.960983 | 1.755200 | 27.5305 |
| S7 | −56.65984 | 3.000000 | 1.744001 | 44.8991 |
| S8 | 233.93701 | 10.000000 | | |
| S9 | 104.72297 | 6.000000 | 1.744001 | 44.8991 |
| S10 | INFINITY | 2.305673 | | |
| S11 | 44.49409 | 10.000000 | 1.744001 | 44.8991 |
| S12 | INFINITY | 10.000000 | 1.688930 | 31.1605 |
| S13 | 30.89249 | 20.698549 | | |
| S14(stop) | INFINITY | 18.053872 | | |
| S15 | −30.35809 | 10.000000 | 1.755200 | 27.5305 |
| S16 | INFINITY | 10.000000 | 1.743299 | 49.2216 |
| S17 | −49.34386 | 15.000000 | | |
| S18 | −159.14781 | 6.000000 | 1.670028 | 47.1965 |
| S19 | −73.10464 | 0.500000 | | |
| S20 | INFINITY | 6.000000 | 1.531720 | 48.8408 |
| S21 | −140.55668 | 145.968602 | | |
| S22(image) | INFINITY | | | |

In FIG. 5, an x-axis denotes a spatial frequency, and a y-axis denotes a modulation. Referring to FIG. 7, the lens apparatus 20C of the present exemplary embodiment shows a resolving power of about 38% based on 96 cycles/mm, which is the Nyquist frequency.

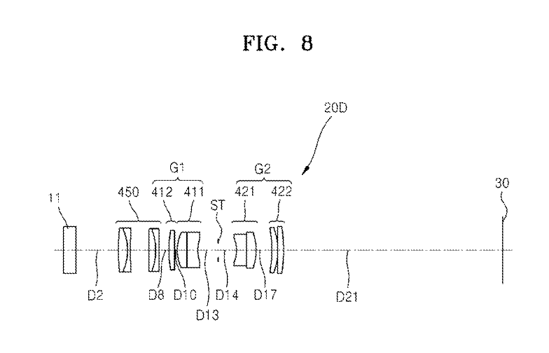

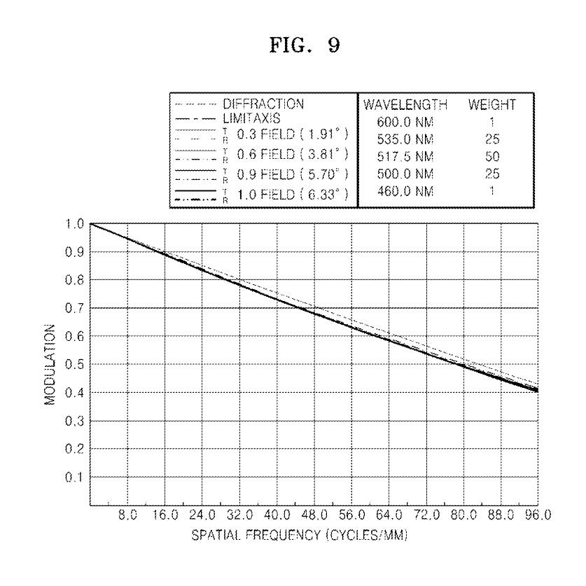

FIG. 8 is a diagram showing the lens apparatus 20D according to another exemplary embodiment, and FIG. 9 is an MTF graph showing a resolving power of the lens apparatus 20D of FIG. 8.

The lens apparatus 20D of the present exemplary embodiment includes a basic lens group that is designed to use a wavelength of red light as a reference wavelength, and includes a converter lens group 450 to perform a second conversion.

According to the second conversion of the converter lens group 450, a lens apparatus having a basic lens group designed to use a wavelength of a single color light, that is, red light, is converted into the lens apparatus 20D using a wavelength of the single color light, that is, green light, as a reference wavelength.

That is, according to the present exemplary embodiment, the lens apparatus including the basic lens group initially designed to use the wavelength of the single color light, that is, the red light, and having a magnification of ×1.3 is converted into the lens apparatus 20D using the wavelength of the green light as the reference wavelength and having a magnification of ×1.3 by the converter lens group 450.

Referring to FIG. 8, the lens apparatus 20D includes the first and second lens groups G1 and G2 that are disposed on opposite sides of the aperture ST. The 1-1 lens group 411 and the 2-1 lens group 421 that include cemented lenses and have negative refractive powers, respectively, are disposed on opposite sides of the aperture ST. The 1-2 lens group 412 having a positive refractive power is disposed at an object side of the 1-1 lens group 411, and the 2-2 lens group 422 having a positive refractive power is disposed at an image side of the 2-1 lens group 421.

The converter lens group 450 includes four lenses.

Table 4 shows design data of the lens apparatus 20D shown in FIG. 8. In the present exemplary embodiment, a distance between the PCB and the prism, that is, the beam splitter 11, is 49.0000 mm.

Fno.=4.5 (effective Fno. 9.3)

EFL=136 mm

magnification=×1.3

TABLE 4

| Lens surface | | | | |
|---|---|---|---|---|
| (Sn) | Rn | Dn | nd | vd |
| S1 | INFINITY | 12.000000 | 1.516800 | 64.1673 |
| S2 | INFINITY | 42.253034 | | |
| S3 | 240.45656 | 8.632177 | 1.620409 | 60.3438 |
| S4 | −63.51302 | 3.000000 | 1.755200 | 27.5305 |
| S5 | 292.91021 | 18.767400 | | |
| S6 | INFINITY | 6.600423 | 1.755200 | 27.5305 |
| S7 | −62.04742 | 3.000000 | 1.620409 | 60.3438 |
| S8 | INFINITY | 10.000000 | | |
| S9 | 104.72297 | 6.000000 | 1.744001 | 44.8991 |
| S10 | INFINITY | 2.305673 | | |
| S11 | 44.49409 | 10.000000 | 1.744001 | 44.8991 |
| S12 | INFINITY | 10.000000 | 1.688930 | 31.1605 |
| S13 | 30.89249 | 20.698549 | | |
| S14(stop) | INFINITY | 18.053872 | | |
| S15 | −30.35809 | 10.000000 | 1.755200 | 27.5305 |
| S16 | INFINITY | 10.000000 | 1.743299 | 49.2216 |
| S17 | −49.34386 | 15.000000 | | |
| S18 | −159.14781 | 6.000000 | 1.670028 | 47.1965 |
| S19 | −73.10464 | 0.500000 | | |
| S20 | INFINITY | 6.000000 | 1.531720 | 48.8408 |
| S21 | −140.55668 | 217.264081 | | |
| S22(image) | INFINITY | | | |

In FIG. 8, an x-axis denotes a spatial frequency, and a y-axis denotes a modulation. Referring to FIG. 8, the lens apparatus 20D of the present exemplary embodiment shows a resolving power of about 40% based on 96 cycles/mm, which is the Nyquist frequency.

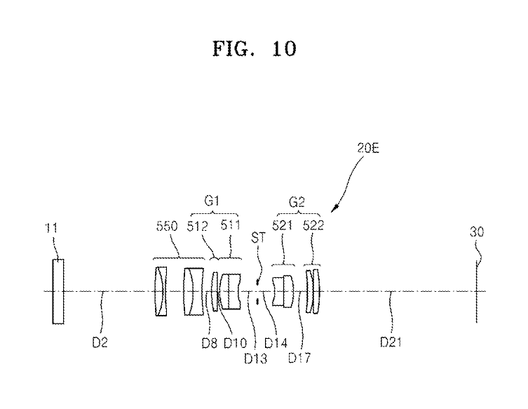

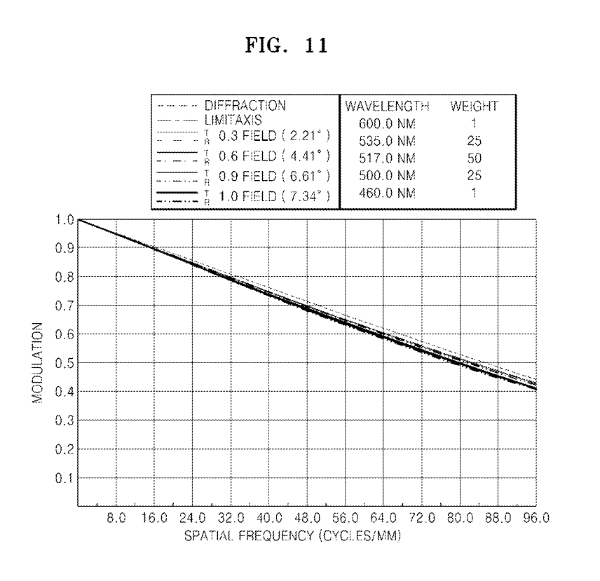

FIG. 10 is a diagram showing the lens apparatus 20E according to another exemplary embodiment, and FIG. 11 is an MTF graph showing a resolving power of the lens apparatus 20E of FIG. 10.

The lens apparatus 20E of the present exemplary embodiment includes a basic lens group that is designed to use a wavelength of red light as a reference wavelength, and further includes a converter lens group 550 to perform first and second conversions.

A lens apparatus having a basic lens group at an initial magnification of ×1.3 is converted into the lens apparatus 20E having a magnification of ×0.867 by the first conversion of the converter lens group 550. In addition, the lens apparatus only including the basic lens group designed to use a wavelength of a single color light, that is, red light, is converted into the lens apparatus 20E using a wavelength of a single color light, that is, green light, as a reference wavelength by the second conversion of the converter lens group 550.

That is, according to the present exemplary embodiment, the basic lens group including the first and second lens groups G1 and G2 is initially designed to use the wavelength of the single color light, that is, the red light, and having a magnification of ×1.3. The basic lens group is converted into the lens apparatus 20E using the wavelength of the green light as the reference wavelength and having a magnification of ×0.867 by the converter lens group 550.

Referring to FIG. 10, the lens apparatus 20E includes the first and second lens groups G1 and G2 that are disposed on opposite sides of the aperture ST. The 1-1 lens group 511 and the 2-1 lens group 521 that include cemented lenses and have negative refractive powers, respectively, are disposed on opposite sides of the aperture ST. The 1-2 lens group 512 having a positive refractive power is disposed at an object side of the 1-1 lens group 511, and the 2-2 lens group 522 having a positive refractive power is disposed at an image side of the 2-1 lens group 521.

The converter lens group 550 includes four lenses.

Table 5 shows design data of the lens apparatus 20E shown in FIG. 10. In the present exemplary embodiment, a distance between the PCB and the prism, that is, the beam splitter 11, is 49.0000 mm.

Fno.=5.3 (effective Fno. 9.1)

EFL=141 mm

magnification=x0.867

TABLE 5

| Lens surface | | | | |
|---|---|---|---|---|
| (Sn) | Rn | Dn | nd | vd |
| S1 | INFINITY | 12.000000 | 516800 | 64.1673 |
| S2 | INFINITY | 95.947053 | | |
| S3 | 240.45656 | 8.632177 | 620409 | 60.3438 |
| S4 | −63.51302 | 3.000000 | 755200. | 27.5305 |
| S5 | 292.91021 | 19.160175 | | |
| S6 | 246.09958 | 10.000000 | 755200 | 275305 |
| S7 | −73.71720 | 9.207648 | 607381 | 56.6572 |
| S8 | 192.56967 | 10.000000 | | |
| S9 | 104.72297 | 6.000000 | 744001 | 44.8991 |
| S10 | INFINITY | 2.305673 | | |
| S11 | 44.49409 | 10.000000 | 744001 | 44.8991 |
| S12 | INFINITY | 10.000000 | 688930 | 31.1605 |
| S13 | 30.89249 | 20.698549 | | |
| S14(stop) | INFINITY | 18.053872 | | |
| S15 | −30.35809 | 10.000000 | 755200 | 27.5305 |
| S16 | INFINITY | 10.000000 | 743299 | 49.2216 |
| S17 | −49.34386 | 15.000000 | | |
| S18 | −159.14781 | 6.000000 | 670028 | 47.1965 |
| S19 | −73.10464 | 0.500000 | | |
| S20 | INFINITY | 6.000000 | 531720 | 48.8408 |
| S21 | −140.55668 | 166.63613 | | |
| S22(image) | INFINITY | | | |

In FIG. 11, an x-axis denotes a spatial frequency, and a y-axis denotes a modulation. Referring to FIG. 11, the lens apparatus 20E of the present exemplary embodiment shows a resolving power of about 40% based on 96 cycles/mm, which is the Nyquist frequency.

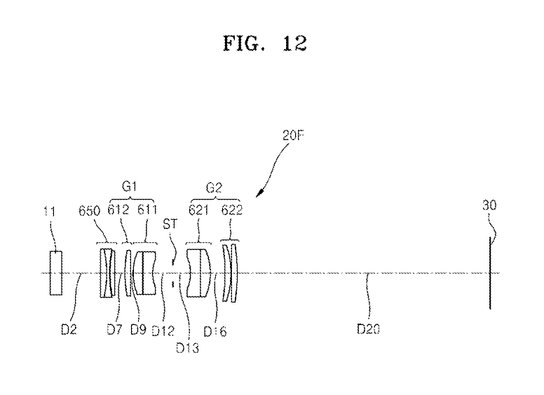

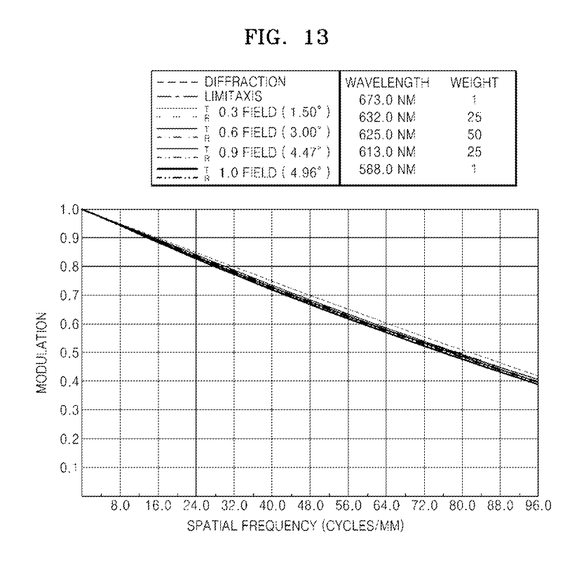

FIG. 12 is a diagram showing the lens apparatus 20F according to another exemplary embodiment, and FIG. 13 is an MTF graph showing a resolving power of the lens apparatus 20F of FIG. 12.

The lens apparatus 20F of the present exemplary embodiment includes a basic lens group that is designed to use a wavelength of red light as a reference wavelength, and further includes a converter lens group 650 to perform a first conversion.

According to the first conversion of the converter lens group 650, the lens apparatus having a basic lens group having an initial magnification of ×1.3 is converted into the lens apparatus 20F having a magnification of ×1.73.

That is, according to the present exemplary embodiment, the lens apparatus including the basic lens group initially designed to use a wavelength of a single color light, that is, red light, and having a magnification of ×1.3 is converted into the lens apparatus 20F using the wavelength of the red light as the reference wavelength and having a magnification of ×1.73 by the converter lens group 650.

Referring to FIG. 12, the lens apparatus 20F includes the first and second lens groups G1 and G2 that are disposed on opposite sides of the aperture ST. The 1-1 lens group 611 and the 2-1 lens group 621 that include cemented lenses and have negative refractive powers, respectively, are disposed on opposite sides of the aperture ST. The 1-2 lens group 612 having a positive refractive power is disposed at an object side of the 1-1 lens group 611, and the 2-2 lens group 622 having a positive refractive power is disposed at an image side of the 2-1 lens group 621.

The converter lens group 650 includes three lenses.

Table 6 shows design data of the lens apparatus 20F shown in FIG. 12. In the present exemplary embodiment, a distance between the PCB and the prism, that is, the beam splitter 11, is 49.0000 mm.

Fno.=3.0 (effective Fno. 7.9)

EFL=136 mm

magnification=×1.73

TABLE 6

| Lens surface | | | | |
|---|---|---|---|---|
| (Sn) | Rn | Dn | nd | vd |
| S1 | INFINITY | 12.000000 | 1.516800 | 64.1673 |
| S2 | INFINITY | 39.000000 | | |
| S3 | −563.08569 | 5.998893 | 1.744001 | 44.8991 |
| S4 | −93.49710 | 3.000000 | 1.548140 | 45.8207 |
| S5 | 104.44924 | 0.714269 | | |
| S6 | 110.00000 | 4.989306 | 1.620409 | 60.3438 |
| S7 | INFINITY | 10.000000 | | |
| S8 | 104.72297 | 6.000000 | 1.744001 | 44.8991 |
| S9 | INFINITY | 2.305673 | | |
| S10 | 44.49409 | 10.000000 | 1.744001 | 44.8991 |
| S11 | INFINITY | 10.000000 | 1.688930 | 31.1605 |
| S12 | 30.89249 | 20.698549 | | |
| S13 | INFINITY | 18.053872 | | |
| S14(stop) | −30.35809 | 10.000000 | 1.755200 | 27.5305 |
| S15 | INFINITY | 10.000000 | 1.743299 | 49.2216 |
| S16 | −49.34386 | 15.000000 | | |
| S17 | −159.14781 | 6.000000 | 1.670028 | 47.1965 |
| S18 | −73.10464 | 0.500000 | | |
| S19 | INFINITY | 6.000000 | 1.531720 | 48.8408 |
| S20 | −140.55668 | 257.123207 | | |
| S21(image) | INFINITY | | | |

In FIG. 13, an x-axis denotes a spatial frequency, and a y-axis denotes an modulation. Referring to FIG. 13, the lens apparatus 20F of the present embodiment shows a resolving power of about 40% based on 96 cycles/mm, which is the Nyquist frequency.

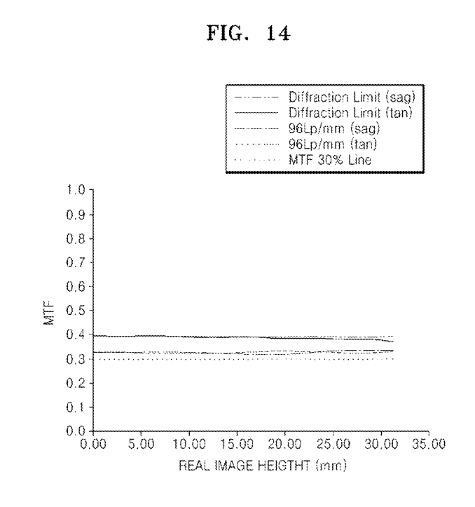

FIG. 14 is an MTF graph showing a resolving power when white light is irradiated onto an object in a comparative example.

Referring to FIG. 14, when the white light is irradiated as the illumination light, a resolving power of about 31.8% is shown based on 96 cycles/mm, which is the Nyquist frequency.

According to exemplary embodiments, a high resolving power may be obtained even when the single color light or two-color light is used, and thus, it may be accurately determined whether the PCB has defects. Referring to the MTF graphs of the embodiment and the comparative example, the resolving power of the machine vision system including the lens apparatus 20 according to the embodiments is superior to that of a machine vision system including a lens apparatus designed based on white light.

According to the exemplary embodiments, an increase in the number of lenses for correcting a chromatic aberration may be prevented. In addition, it is easy to obtain the desired resolving power at lower costs than that of the machine vision system based on the white light. In addition, chromatic aberration may be reduced.

In addition, since a converter lens group is included, the color change of the illumination light that is changed according to the kind of object and the inspection objective may be actively dealt, and efficiency of the machine vision system may be improved greatly by adjusting the magnification.

In the above exemplary embodiments, each of the lens group may be configured by one single lens or a plurality of lens cemented to one single lens as long as the characteristics of each lens group is not changed.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims.

What is claimed is:

1. A machine vision system to determine a state of an object, the machine vision system comprising:
an illuminating apparatus which irradiates light of a first single color or light in which the first single color and a second single color are mixed onto the object; and
a lens apparatus designed to use a wavelength of light of the first single color as a reference wavelength, the lens apparatus comprising a first lens group and a second lens group disposed on opposite sides of an aperture and receiving light reflected by the object,
wherein the lens apparatus further comprises a converter lens group which performs at least one of a first conversion for converting a magnification of the lens apparatus, and a second conversion for converting the reference wavelength of the lens apparatus, and
wherein each of the first, second and converter lens groups comprises one or more lenses.

2. The machine vision system of claim 1, wherein the converter lens group is disposed at an object side of the first lens group.

3. The machine vision system of claim 1, wherein the converter lens group comprises four or less lenses.

4. The machine vision system of claim 1, wherein the first lens group comprises:
a first sub lens group disposed adjacent to the aperture, having a negative refractive power, and comprising at least one lens; and
a second sub lens group disposed at an object side of the first sub lens group, having a positive refractive power, and comprising at least one lens, and
wherein the second lens group comprises:
a first sub lens group disposed adjacent to the aperture, having a negative refractive power, and comprising at least one lens; and
a second sub lens group disposed at an image side of the first sub lens group, having a positive refractive power; and
comprising at least one lens.

5. The machine vision system of claim 1, wherein the illuminating apparatus irradiates the light of the first single color or the light in which the first single color and a second single color are mixed selectively in at least one of the following manners:
(i) the light of the first single color or the light in which the first single color and the second single color are mixed is incident on the object through an optical axis of the lens apparatus; and
(ii) the light of the first single color or the light in which the first single color and the second single color are mixed is incident at an angle inclined with respect to the optical axis of the lens apparatus.

6. The machine vision system of claim 1, further comprising:
a solid state imaging device which converts the light reflected by the object into an electric signal, and stores the electric signal as an image; and
a state determination apparatus which determines the state of the object by using the image.

7. The machine vision system of claim 6, wherein the state determination apparatus determines the state of the object by comparing the image with image information about the object which is stored in advance.

8. A machine vision system to determine a state of an object, the machine vision system comprising:
an illuminating apparatus which irradiates light of a single color onto the object; and
a lens apparatus which is designed to use a wavelength of the light of the single color as a reference wavelength, and comprises a first lens group and a second lens group disposed on opposite sides of an aperture and receiving light reflected by the object,
wherein each of the first, second and converter lens groups comprises one or more lenses.

9. A lens apparatus receiving light reflected from an object, the lens apparatus comprising:
a first lens group and a second lens group which are designed to use a wavelength of light of a first single color as a reference wavelength and disposed on opposite sides of an aperture; and
a converter lens group which is disposed at an object side of the first lens group,
wherein the converter lens group performs selectively at least one of a first conversion for converting a magnification, and a second conversion for converting the reference wavelength.

10. The lens apparatus of claim 9, wherein the first lens group and the second lens group are substantially symmetrical with each other as a Gaussian type about the aperture.

11. The lens apparatus of claim 9, wherein the converter lens group performs both of the first conversion and the second conversion.

12. The lens apparatus of claim 9, wherein the reference wavelength of the first lens group and the second lens group is a wavelength of single color light.

13. The lens apparatus of claim 12, wherein the reference wavelength of the first and second lens groups is a wavelength of red light, and the second conversion of the converter lens group converts the reference wavelength into a wavelength of blue light or green light.

14. The lens apparatus of claim 9, wherein the converter lens group performs only the first conversion among the first and second conversions.

15. The lens apparatus of claim 9, wherein the converter lens group performs only the second conversion among the first and second conversions.
